(19) United States
(12) Patent Application Publication
(10) Pub. No.: US 2009/0319444 A1
(43) Pub. Date: Dec. 24, 2009

(54) FACSIMILE MACHINE AND COMMUNICATION METHOD USED IN THE FACSIMILE MACHINE

(75) Inventors: Takeshi Hibino, Toyokawa-shi (JP); Kentaro Nagatani, Toyokawa-shi (JP); Tomoko Maruyama, Toyokawa-shi (JP); Tsuyoshi Yoneyama, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC, Chiyoda-ku (JP)

(21) Appl. No.: 12/482,489

(22) Filed: Jun. 11, 2009

(30) Foreign Application Priority Data
Jun. 18, 2008 (JP) 2008-159508

(51) Int. Cl. G06Q 10/00; G06Q 50/00; H04N 1/21

(52) U.S. Cl. 705/400; 358/407

(57) ABSTRACT

An image forming apparatus is provided with a document data storage portion for storing document data, a charge calculation portion for performing a charge operation for calculating communication charges to be made for transmission of the document data, a send/receive portion for transmitting the document data to different image forming apparatuses each of which is at the other end of the communication, and a transmission control portion for controlling the charge calculation portion and the send/receive portion such that the charge operation for one of the different image forming apparatuses that is the current transmission destination is performed within the following period: after start of transmission of the document data to another of the different image forming apparatuses that is the last transmission destination, and, before or concurrently with start of transmission of the document data to the different image forming apparatus that is the current transmission destination.

This application is based on Japanese Patent Application No. 2008-159508 filed on Jun. 18, 2008, the contents of which are hereby incorporated by reference.

### BACKGROUND OF THE INVENTION

1. Field of the Invention

The present invention relates to a facsimile machine such as an image forming apparatus, e.g., an MFP, and a communication method used in the facsimile machine.

2. Description of the Related Art

Multifunction devices called combination machines or Multi-Function Peripherals (MFPs) have conventionally been used in offices of business, and the like as image forming apparatuses performing image forming processes. Such image forming apparatuses are processing devices having a variety of functions such as copying, scanning, faxing, and network printing.

Such image forming apparatuses are often used as facsimile machines. In some cases, such facsimile machines are used to perform broadcast transmission. The broadcast transmission means that one facsimile machine sends the identical document data (broadcast data) to a plurality of facsimile machines with a single transmission setting.

With respect to communication charges for facsimile transmission, there is proposed a facsimile machine that can perform broadcast transmission such that communication charges determined depending on, for example, transmission sources, communication hours, and telecommunications companies are lowered (refer to JP 7-327122A).

Conventional facsimile machines optimize the order of transmission destinations in broadcast transmission, taking into account the time at which a transmission source sends a facsimile message, in other words, a communication time frame (communication period). However, the conventional facsimile machines do not actually perform a charging process upon the communication. Disadvantageously, the conventional facsimile machines do not implement an appropriate charge calculation process in the case of a communication format in which communication charges are imposed on a transmission destination.

### SUMMARY

The present disclosure is directed to solve the problems pointed out above, and therefore, an object of an embodiment of the present invention is to implement, in the case of broadcast transmission, a charge calculation process more appropriately than is conventionally possible.

A facsimile machine according to one aspect of the present invention is a facsimile machine capable of performing broadcast transmission in which identical document data is transmitted to a plurality of different facsimile machines each of which is a transmission destination. The facsimile machine includes a storage portion that stores the document data, a charge calculation portion that performs a charge operation for calculating communication charges to be made for transmission of the document data, a transmission portion that transmits the document data stored in the storage portion to each of the different facsimile machines, and a transmission control portion that controls the charge calculation portion and the transmission portion such that the charge operation for one of the different facsimile machines that is a current transmission destination is performed within the following period: after start of transmission of the document data to another of the different facsimile machines that is a last transmission destination, and, before or concurrently with start of transmission of the document data to the different facsimile machine that is the current transmission destination.

### BRIEF DESCRIPTION OF THE DRAWINGS

FIG. 1 is a diagram illustrating an example of the hardware configuration of an image forming apparatus.

FIG. 2 is a diagram illustrating an example of the functional configuration of an image forming apparatus.

FIGS. 3A and 3B are diagrams illustrating an example of a timer programming table and a redial setting table.

FIGS. 4A and 4B are diagrams illustrating an example of a tariff.

FIGS. 5A and 5B are diagrams illustrating an example of charge mapping data.

FIG. 6 is a diagram depicting a charge calculation process in the case of broadcast transmission to five image forming apparatuses at the other end of the communication.

FIG. 7 is a flowchart illustrating an example of the flow of a charge calculation process during broadcast transmission.

FIG. 8 is a flowchart illustrating an example of the flow of a charge calculation process in broadcast transmission when a timer is preprogrammed.

FIG. 9 is a flowchart illustrating an example of the flow of a charge calculation process in broadcast transmission when redialing is set.

### DESCRIPTION OF THE PREFERRED EMBODIMENTS

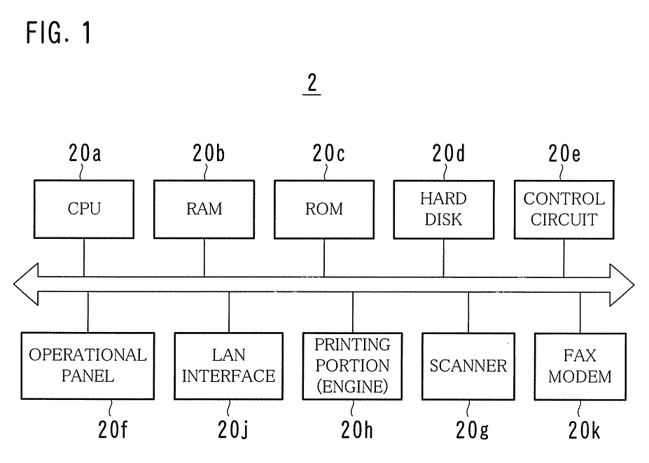

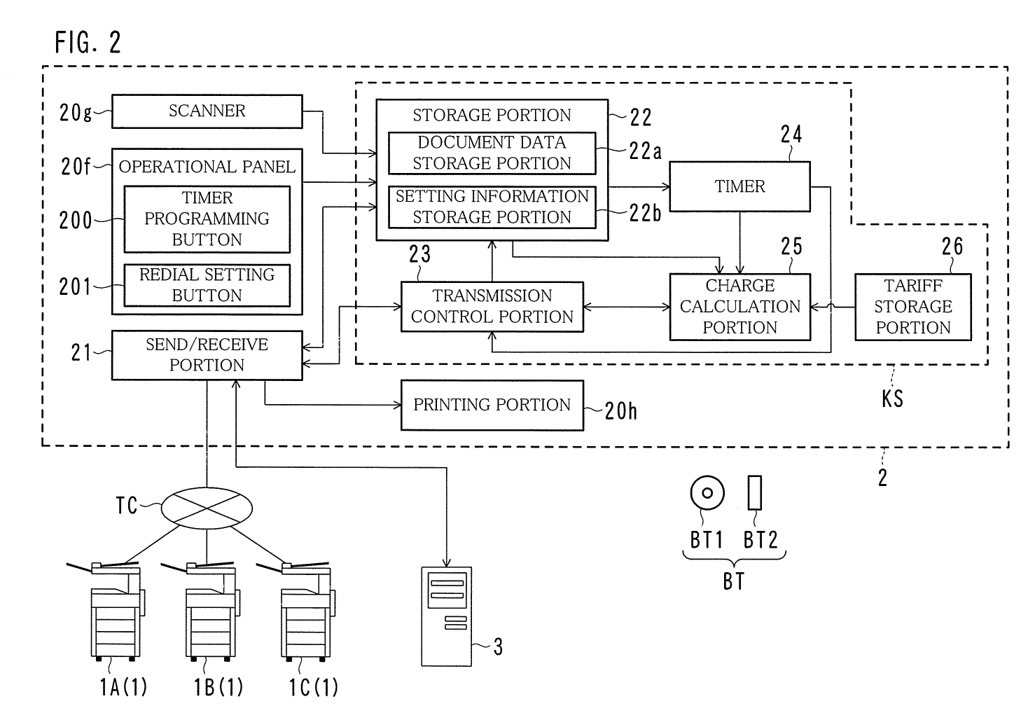

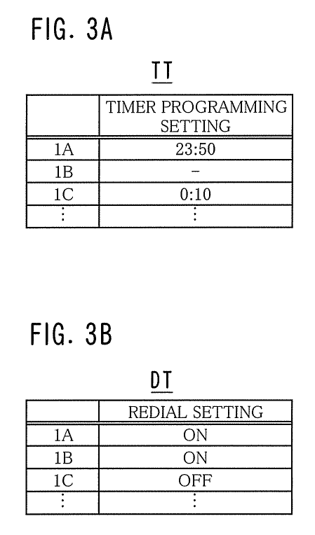

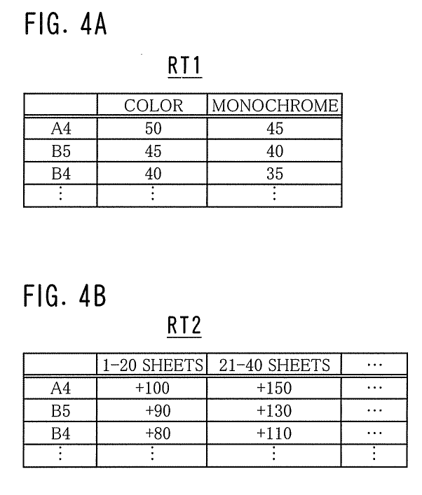

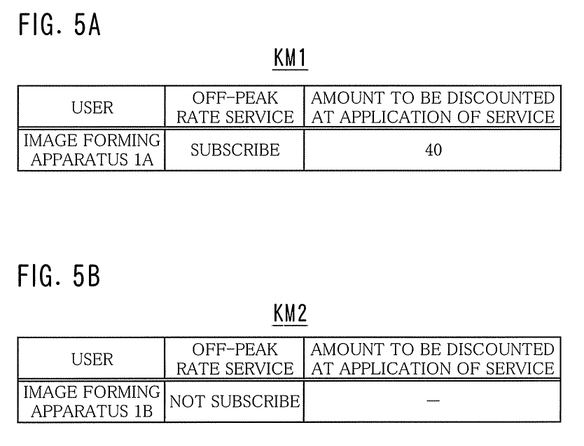

FIG. 1 is a diagram illustrating an example of the hardware configuration of an image forming apparatus 2; FIG. 2 is a diagram illustrating an example of the functional configuration of the image forming apparatus 2; FIGS. 3A and 3B are diagrams illustrating an example of a timer programming table TT and a redial setting table DT; FIGS. 4A and 4B are diagrams illustrating an example of a tariff RT; and FIGS. 5A and 5B are diagrams illustrating an example of charge mapping data KM.

The image forming apparatus (facsimile machine) 2 is a processing device that integrates a variety of functions, such as copying, scanning, faxing, network printing, document server, and so on, into a single unit. Such apparatuses are sometimes called combination machines or Multi-Function Peripherals (MFPs).

A “document server” is a function of providing and managing storage areas that correspond to folders, directories, or the like in a personal computer, which are referred to as “personal boxes” or “boxes” for each user. This may also be referred to as a “box function”. A user can store image data (document data) or the like in his/her personal box on a file-by-file basis.

The image forming apparatus 2 is installed in offices of public organizations (central governments and local governments), offices of business, or the like, public facilities such as schools or libraries, or various other locations, and can be shared by a plurality of users.

Referring to FIG. 1, the image forming apparatus 2 is configured of a CPU 20a, a RAM 20b, a ROM 20c, a hard disk 20d, a control circuit 20e, an operational panel 20f, a scanner 20g, a printing portion (engine) 20h, a LIAN interface 20j, a FAX modem 20k, and so on.

The control circuit 20e is a circuit for controlling the hard disk 20d, the operational panel 20f, the scanner 20g, the printing portion 20h, the LAN interface 20j, the FAX modem 20k, and so on.

The scanner 20g optically reads images of contents printed on paper, such as text, formulas, symbols, photographs, charts, illustrations, and the like, and creates image data (document data) thereof.

The printing portion 20h prints, onto paper, an image based on the image data obtained by the scanner 20g and an image based on document data, and the like received from an external device.

The LAN interface 20j is a Network Interface Card (NIC) for communicating with, for example, a different image forming apparatus, and is used for connecting the image forming apparatus 2 with a hub or a router.

The FAX modem 20k is a device for communicating with, for example, a different image forming apparatus (facsimile machine) based on a facsimile protocol.

The operational panel 20f is configured of a display portion realized by a touch-panel liquid crystal display and an operational portion realized by a numeric keypad and the like.

On the display portion are displayed, for example, a screen for giving a message or instructions to a user, a screen for the user to enter a type of a desired process and process conditions, and a screen for indicating the results of processes executed by the CPU 20a or the like.

The operational panel 20f is provided with a timer programming button 200 (refer to FIG. 2) for preprogramming a time at which document data is to be transmitted to a different image forming apparatus, and a redial setting button 201 (refer to FIG. 2) for enabling redial setting through which, if document data is not transmitted normally, transmission of the document data is attempted again.

The user views the screens described above and operates the display portion or the operational portion. Thereby, the user can provide a command to start or stop the execution of a process, specify a data destination, printing conditions, or processing conditions such as scanning conditions, and specify various other items to the image forming apparatus 2. The operational panel 20f therefore serves as a user interface through which the user operates the image forming apparatus 2.

Referring to FIG. 2, the image forming apparatus 2 is configured of a send/receive portion 21, a storage portion 22, a transmission control portion 23, a timer 24, a charge calculation portion 25, a tariff storage portion 26, and the like. The storage portion 22 is configured of a document data storage portion 22a and a setting information storage portion 22b. Further, the storage portion 22, the transmission control portion 23, the timer 24, the charge calculation portion 25, and the tariff storage portion 26 constitute a charge transmission portion KS.

A description is given of a case where the send/receive portion 21 performs a process of sequentially sending the identical document data to a plurality of image forming apparatuses with a single setting (hereinafter, such a process is referred to as “broadcast transmission”). In such a case, according to this embodiment, every time the other end of the communication is changed from one to another, the charge calculation portion 25 performs a charge operation for calculating communication charges to be paid by a user of an image forming apparatus that is supposed to receive the identical document data. The detailed description is provided below.

The image forming apparatus 2 is connected, via or without via a communication line TC, to image forming apparatuses (facsimile machines) 1A, 1B, 1C, and so on each of which is at the other end of the communication, and to a charging server 3. For the convenience of description, the image forming apparatus 1A, 1B, 1C, or the like at the other end of the communication is hereinafter referred to as simply the image forming apparatus 1A, 1B, 1C, or the like. Further, the image forming apparatuses 1A, 1B, 1C, and so on are sometimes collectively denoted by reference numeral 1. A LAN, the Internet, a public line, a wireless line, a dedicated line, or the like may be used as the communication line TC.

The CPU 20a executes programs stored in the RAM 20b or the ROM 20c, thereby to functionally implement the storage portion 22, the transmission control portion 23, the timer 24, the charge calculation portion 25, and the tariff storage portion 26. Such programs can be installed from a portable recording medium BT, for example, a recording medium BT1 such as a CD-ROM or a DVD-ROM having the programs recorded thereon, and a recording medium BT2 such as a semiconductor memory having the programs recorded thereon. Alternatively, the programs can be downloaded from a server via a network.

In some cases, the whole or a part of the storage portion 22, the transmission control portion 23, the timer 24, the charge calculation portion 25, and the tariff storage portion 26 is sometimes implemented for use as an Application Specific Integrated Circuit (ASIC) in a form of LSI and implemented by firmware or hardware.

The scanner 20g scans an original document to generate document data thereof. The document data thus generated is stored in the document data storage portion 22a.

The send/receive portion 21 transmits the document data stored in the document data storage portion 22a to the image forming apparatus 1 via the communication line TC.

A user can operate the timer programming button 200 of the operational panel 20f to preprogram a timer so that the send/receive portion 21 performs transmission of document data at a time specified by preprogramming the timer. Information on timer thus preprogrammed by the user, i.e., timer programming information is stored in the timer programming table TT of the setting information storage portion 22b as illustrated in FIG. 3A. The timer programming table TT stores timer programming information indicating, for example, that document data is to be transmitted to the image forming apparatus 1A at 23:50. Note that the timer 24 serves to measure time.

The user can operate the redial setting button 201 of the operational panel 20f to perform redial setting. The redial setting is performed to attempt to send again document data that has not been sent normally by the send/receive portion 21. As illustrated in FIG. 3B, information on redial setting, i.e., redial setting information is stored in the redial setting table DT of the setting information storage portion 22b. The redial setting table DT stores redial setting information indicating, for example, that a fax number of the image forming apparatus 1A is to be redialed.

The transmission control portion 23 starts (initiates) a transmission control process when the user operates the operational panel 20f to set transmission conditions such as a paper size, resolution, color/monochrome, destination, and broadcast transmission mode, and then an original document is completely scanned. The number of documents to be sent is determined at a time when the original document is completely scanned. The number of documents to be sent may be entered through the operational panel 20f. The transmission control process is a preparation process necessary to send document data, and involves, for example, starting the send/receive portion 21 implemented by a FAX modem, or the like. In the case where the timer is preprogrammed, the transmission control portion 23 starts the transmission control process at a time specified by preprogramming the timer.

In this embodiment, the transmission control portion 23 controls the charge calculation portion 25 and the send/receive portion 21 so that charges to be imposed on the image forming apparatus 1 that is the current transmission destination in broadcast transmission are calculated within the following period (time frame): After the start of transmission of document data to an image forming apparatus 1 that is the last transmission destination, and, before or concurrently with the start of transmission of the document data to the image forming apparatus 1 that is the current transmission destination.

More specifically, the charge calculation portion 25 performs a charge calculation process for the first transmission destination at a time when the transmission control portion 23 starts a transmission control process.

The charge calculation portion 25 performs a charge calculation process for each of the second and succeeding transmission destinations at a time after the completion of transmission of the document data to the last transmission destination and, at the same time, when a transmission control process for the current transmission destination starts. Note that, in this embodiment, communication charges that are calculated by the charge calculation portion 25 and are made for transmission of the document data shall be paid by a user of the image forming apparatus 1.

In the specific example described above, a charge calculation process for the current transmission destination is performed at a time when a transmission control process for the current transmission destination starts. Instead, however, such a charge calculation process may be performed at a time when transmission of document data is started.

In short, according to this embodiment, a charge calculation process is performed every time a transmission destination is changed from one to another and, at the same time, is performed at a time when transmission of document data to a transmission destination is started or immediately before that time.

When redial setting has been performed, the charge calculation portion 25 updates information on the amount of charges that is calculated the last time to information on the amount of charges that is calculated upon redialing.

The charge calculation portion 25 performs a charge calculation process based on a tariff stored in the tariff storage portion 26 and charge mapping data obtained from the charging server 3. The two tariffs discussed below can be used in this embodiment. The charging server 3 is managed by, for example, a variety of telecommunications companies, convenience stores, or a variety of businesses.

As illustrated in FIG. 4A, a tariff RT1 indicates information on communication charges based on a paper size of an original document and an output type, i.e., color/monochrome output. Referring to the tariff RT1, for example, communication charges are 50 Yen when the original document is A4-size paper and color output is desired.

As illustrated in FIG. 4B, a tariff RT2 indicates information on communication charges based on a paper size of an original document and the number of original documents (the number of documents to be received), that is, information on communication charges to be added to the communication charges specified in the tariff RT1. Referring to the tariff RT2, for example, an additional amount is 100 Yen when the original document is A4-size paper and the number of original documents is 10.

Accordingly, if the image forming apparatus 1 receives document data of ten sheets of A4-size color original documents, communication charges calculated by the charge calculation portion 25 are 150 Yen, which is derived from the equation 50+100 based on the tariffs RT1 and RT2. The tariff may have the item of resolution, and communication charges may be set also depending on the resolution.

Referring to FIGS. 5A and 5B, the charge mapping data KM indicates information as to whether or not the corresponding image forming apparatus subscribes an off-peak rate service, and information on the amount to be discounted when the off-peak rate service is available. The charge mapping data KM is prepared for each image forming apparatus 1.

For example, the charge mapping data KM1 indicates that the image forming apparatus 1A subscribes an off-peak rate service and the amount to be discounted is 40 Yen if the service is available. The charge mapping data KM2 indicates that the image forming apparatus 1B does not subscribe an off-peak rate service.

The following is one example of the charge calculation based on the tariffs RT1 and RT2, and the charge mapping data KM1. If document data of ten sheets of A4-size color original documents is sent to the image forming apparatus 1A during a period (time frame) in which an off-peak rate service is available, communication charges calculated by the charge calculation portion 25 are 110 Yen, which is derived from the equation 50+100−40.

The off-peak rate service is a service of, when document data is sent during a predetermined period, e.g., 0:00 to 06:00, discounting a predetermined amount from communication charges obtained as a result of the charge calculation process. Hereinafter, communication charges after the application of such an off-peak rate service are sometimes referred to as a “discounted rate”, while communication charges to which such an off-peak rate service is not applied are sometimes referred to as a “normal rate”.

A description will be given below of a process flow during a specific period with reference to a drawing.

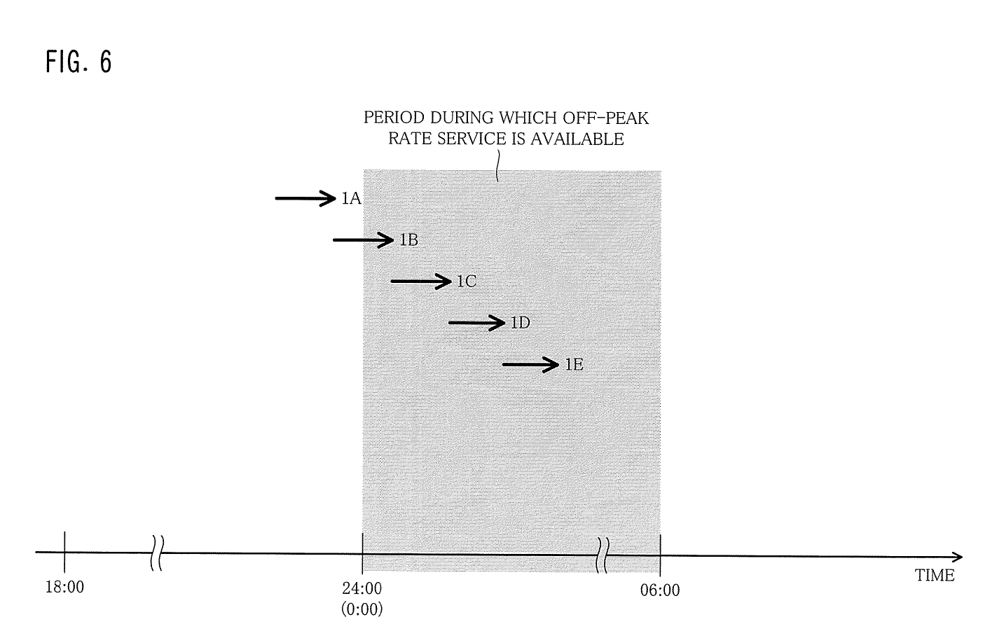

FIG. 6 is a diagram depicting a charge calculation process in the case of broadcast transmission to the five image forming apparatuses 1A to 1E.

As illustrated in FIG. 6, it is assumed that a period during which an off-peak rate service is available is between 0:00 and 06:00, and the image forming apparatuses 1A, 1C and 1E subscribe the off-peak rate service.

For example, a user sets a broadcast transmission mode at 23:30. Then, the user operates a start key or the like to scan an image of an original document at 23:35. After that, a transmission control process for the image forming apparatus 1A starts at 23:40, and at this timing, namely, at a time when the transmission control process starts, a charge calculation process for the image forming apparatus 1A is performed.

In this case, communication charges to be imposed on the image forming apparatus 1A are at a normal rate, although the image forming apparatus 1A subscribes the off-peak rate service. Because the charge calculation process is performed during a period in which the off-peak rate service is not available.

The charge calculation process is completed at 23:45, and then, the send/receive portion 21 obtains document data from the document data storage portion 22a to transmit the document data thus obtained to the image forming apparatus 1A.

The document data is completely transmitted to the image forming apparatus 1A at 23:55. Along with the completion of the transmission, a transmission control process for the image forming apparatus 1B starts. At a time when the transmission control process starts, a charge calculation process for the image forming apparatus 1B is performed. In this case, communication charges to be imposed on the image forming apparatus 1B are at a normal rate. Because the charge calculation process is performed during a period in which the off-peak rate service is not available, and, in the first place, the image forming apparatus 1B does not subscribe the off-peak rate service.

The charge calculation process is completed at 0:00, and subsequently, the send/receive portion 21 transmits the document data to the image forming apparatus 1B.

The document data is completely transmitted to the image forming apparatus 1B at 0:10. Along with the completion of the transmission, a transmission control process for the image forming apparatus 1C starts. At a time when the transmission control process starts, a charge calculation process for the image forming apparatus 1C is performed. In this case, communication charges to be imposed on the image forming apparatus 1C are at a discounted rate. Because the charge calculation process is performed during a period in which the off-peak rate service is available, and further, the image forming apparatus 1C subscribes the off-peak rate service.

The charge calculation process is completed at 0:15, and subsequently, the send/receive portion 21 transmits the document data to the image forming apparatus 1C.

The document data is completely transmitted to the image forming apparatus 1C at 0:25. Along with the completion of the transmission, a transmission control process for the image forming apparatus 1D starts. At a time when the transmission control process starts, a charge calculation process for the image forming apparatus 1D is performed. In this case, communication charges to be imposed on the image forming apparatus 1D are at a normal rate. Because the image forming apparatus 1D does not subscribe the off-peak rate service, although the charge calculation process is performed during a period in which the off-peak rate service is available.

The charge calculation process is completed at 0:30, and then, the send/receive portion 21 transmits the document data to the image forming apparatus 1D.

The document data is completely transmitted to the image forming apparatus 1D at 0:40. Along with the completion of the transmission, a transmission control process for the image forming apparatus 1E starts. At a time when the transmission control process starts, a charge calculation process for the image forming apparatus 1E is performed. In this case, communication charges to be imposed on the image forming apparatus 1E are at a discounted rate. Because the charge calculation process is performed during a period in which the off-peak rate service is available, and further, the image forming apparatus 1E subscribes the off-peak rate service.

The charge calculation process is completed at 0:45, and subsequently, the send/receive portion 21 transmits the document data to the image forming apparatus 1E.

The document data is completely sent to the image forming apparatus 1E at 0:55, which means that the broadcast transmission of the document data has been completed. Thereafter, the send/receive portion 21 sends, to the charging server 3, click information indicating, for example, that the document data has been sent to the five image forming apparatuses 1A-1E.

As described above, in the case of broadcast transmission of document data, a charge calculation process is performed every time a transmission destination of the document data is changed from one to another.

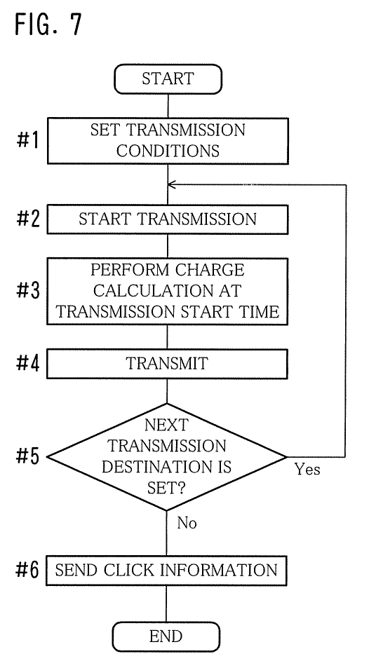

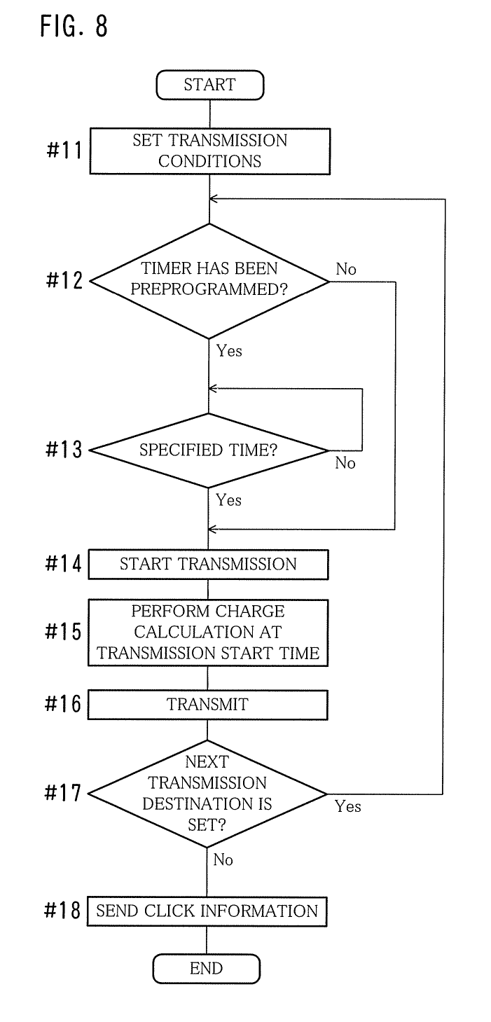

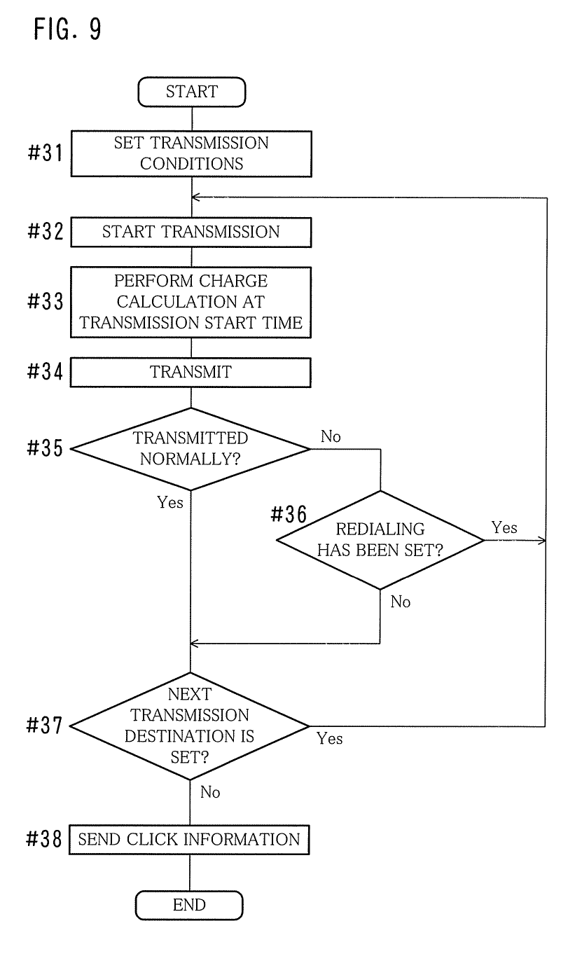

FIG. 7 is a flowchart illustrating an example of the flow of a charge calculation process during broadcast transmission; FIG. 8 is a flowchart illustrating an example of the flow of a charge calculation process in broadcast transmission when a timer is preprogrammed; and FIG. 9 is a flowchart illustrating an example of the flow of a charge calculation process in broadcast transmission when redialing is set.

Referring to FIG. 7, first, transmission conditions are set (#1). Then, a transmission control process is started (#2). Responding to this, a charge calculation process is performed at a time when the transmission control process is started (#3). Thereafter, document data is transmitted to the current transmission destination (#4).

When the document data is completely transmitted to the current transmission destination, it is determined whether or not the next transmission destination is set (#5). If the next transmission destination is set (Yes in #5), then the process from Step #2 through Step #4 is performed also on the next transmission destination. On the other hand, if the next transmission destination is not set (No in #5), then the image forming apparatus 2 sends click information to the charging server 3 (#6), and then the process ends.

Referring to FIG. 8, first, transmission conditions are set (#11). Then, it is determined whether or not a timer has been preprogrammed (#12).

If the timer has been preprogrammed (Yes in #12), then it is determined whether or not the time has reached a time specified by preprogramming the timer (#13).

At the specified time (Yes in #13), or, alternatively, when the timer has not been preprogrammed (No in #12), a transmission control process is started (#14). Then, a charge calculation process is performed at a time when the transmission control process is started (#15). Thereafter, the document data is transmitted to the current transmission destination (#16).

When the document data is completely transmitted to the current transmission destination, it is determined whether or not the next transmission destination is set (#17). If the next transmission destination is set (Yes in #17), then the process from Step #12 through Step #16 is performed also on the next transmission destination. On the other hand, if the next transmission destination is not set (No in #17), then the image forming apparatus 2 sends click information to the charging server 3 (#18), and then the process ends.

With the illustrated example in FIG. 8, if a timer has been preprogrammed, for example, only for the image forming apparatus 1B among the image forming apparatuses 1A-1C, the processes on the image forming apparatuses 1A and 1C take precedence over the process on the image forming apparatus 1B. This prevents undue delay in sending the document data to the image forming apparatuses 1A and 1C for both of which a timer has not been preprogrammed.

Referring to FIG. 9, first, transmission conditions are set (#31). Then, a transmission control process is started (#32). Responding to this, a charge calculation process is performed at a time when the transmission control process is started (#33). Thereafter, the document data is transmitted to the current transmission destination (#34).

It is determined whether or not the connection has been established normally, that is, whether or not the document data has been sent normally to the current transmission destination (#35).

If the document data has not been sent normally (No in #35), then it is determined whether or not redialing has been set (#36). If the redialing has been set (Yes in #36), then the process from Step #32 through Step #35 is repeated on the current transmission destination.

On the other hand, if the document data has been sent normally (Yes in #35), or alternatively, if the document data has not been sent normally (No in #35) and further redialing has not been set (No in #36), then it is determined whether or not the next transmission destination is set (#37). If the next transmission destination is set (Yes in #37), then the process from Step #32 through Step #36 is performed also on the next transmission destination. On the other hand, if the next transmission destination is not set (No in #37), then the image forming apparatus 2 sends click information to the charging server 3 (#38), and then the process ends.

In this embodiment, in the case of broadcast transmission, a charge calculation process is performed every time a transmission control process for each image forming apparatus 1 starts, that is, every time a transmission destination is changed from one to another. This prevents the following situation: A user of the image forming apparatus 1 is required to pay a higher amount than the amount of communication charges that is to be originally paid by the user, although document data is transmitted during a period in which an off-peak rate service is available, which is because a charge calculation process is performed during a period in which the off-peak rate service is not available.

In some cases, a period during which a charge calculation process is performed differs between the last dialing and redialing, depending on the number of times of redialing or the time interval thereof.

As described above, for example, it is assumed that a transmission destination subscribes an off-peak rate service, a time at which the last dialing (charge calculation) is performed is 23:55, and a time at which redialing (charge calculation) is performed is 0:05. In such a case, conventional technologies require the transmission destination to pay the amount of charges upon the last dialing although document data is actually transmitted during a period in which the off-peak rate service is available.

In contrast, according to this embodiment, even when transmission is not performed normally in broadcast transmission, a charge calculation process is performed every time redialing is performed. Thus, it is possible to prevent a user of the image forming apparatus 1 from paying a higher amount than the amount of communication charges that is to be originally paid by the user.

While document data is being transmitted, in some cases, a first period during which an off-peak rate service is available is turned into a second period during which the off-peak rate service is not available, or alternatively, the second period is turned into the first period. In such cases, the amount of charges has conventionally been different between before and after turning one period into the other. Conversely, in this embodiment, a charge calculation process is performed every time a transmission destination is changed from one to another. This prevents the difference in the amount of charges between before and after turning one period into the other.

Thus, in the case of broadcast transmission, the image forming apparatus 2 can implement a charge calculation process more appropriately than is conventionally possible.

### Other Embodiments

In the embodiment discussed above, color output charges or monochrome output charges for each paper size are stored in the tariff RT1. Instead, however, it may be stored in the form of charge mapping data KM.

The items and amounts in the tariffs RT1 and RT2 and the charge mapping data KM are just an example, and can be set appropriately.

Further, in the embodiment described above, communication charges for transmission of document data are paid by a user of the image forming apparatus 1. Instead, however, such communication charges may be paid by a user of the image forming apparatus 2 that is the transmission source.

In the embodiments discussed above, the overall configuration of the image forming apparatus 2, the configurations of various portions thereof, the content to be processed, the processing order, and the like may be altered as required in accordance with the subject matter of the present invention. In such a case, the unique and distinguished advantageous effects described above can be produced in such a case as well.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A facsimile machine capable of performing broadcast transmission in which identical document data is transmitted to a plurality of different facsimile machines each of which is a transmission destination, the facsimile machine comprising:
a storage portion that stores the document data;
a charge calculation portion that performs a charge operation for calculating communication charges to be made for transmission of the document data;
a transmission portion that transmits the document data stored in the storage portion to each of the different facsimile machines; and
a transmission control portion that controls the charge calculation portion and the transmission portion such that the charge operation for one of the different facsimile machines that is a current transmission destination is performed within the following period: after start of transmission of the document data to another of the different facsimile machines that is a last transmission destination, and, before or concurrently with start of transmission of the document data to said one of the different facsimile machines that is the current transmission destination.

2. The facsimile machine according to claim 1, wherein the charge calculation portion performs the charge operation based on a tariff.

3. The facsimile machine according to claim 2, wherein the tariff sets out communication charges based on at least one of an original paper size, an output color, an original document amount, and a resolution.

4. The facsimile machine according to claim 1, wherein the charge calculation portion performs the charge operation based on charging system information for each of the different facsimile machines.

5. The facsimile machine according to claim 4, wherein the charging system information for each of the different facsimile machines is obtained from an external device.

6. The facsimile machine according to claim 1, further comprising a timer programming portion that sets, for each of the different facsimile machines, a specified time for transmission of the document data,
wherein the transmission control portion controls the transmission portion such that transmission of the document data is started at the specified time.

7. The facsimile machine according to claim 1, further comprising a redial setting portion that enables, for each of the different facsimile machines, redial setting through which, if the document data is not transmitted normally by the transmission portion, transmission of the document data is attempted again,
wherein if the redial setting is performed by the redial setting portion, and further, if the document data is not transmitted normally by the transmission portion, the transmission control portion controls the charge calculation portion to perform the charge operation again for update before start of transmission of the document data again by the transmission portion.

8. A communication method used in a facsimile machine capable of performing broadcast transmission in which identical document data is transmitted to a plurality of different facsimile machines each of which is a transmission destination, the communication method comprising:
performing, in the broadcast transmission, a charge operation for calculating communication charges to be made for transmission of the document data every time the transmission destination is changed from one to another,
wherein the charge operation is performed before or concurrently with start of transmission of the document data to the transmission destination thus changed.

9. A communication method used in a facsimile machine capable of performing broadcast transmission in which identical document data is successively transmitted to a first different facsimile machine and a second different facsimile machine each of which is a transmission destination, the communication method comprising:
performing a charge operation for calculating communication charges to be made for transmission of the document data to the first different facsimile machine;
transmitting the document data to the first different facsimile machine;
performing a charge operation for calculating communication charges to be made for transmission of the document data to the second different facsimile machine; and
transmitting the document data to the second different facsimile machine.

10. The communication method according to claim 9, wherein the charge operation for calculating the communication charges is performed based on charging system information for each of the first different facsimile machine and the second different facsimile machine.
